(19) United States
(12) Patent Application Publication
(10) Pub. No.: US 2008/0098476 A1
(43) Pub. Date: Apr. 24, 2008

(54) Method and Apparatus for Defending Against Zero-Day Worm-Based Attacks

(75) Inventor: Jason M Syversen, Dunbarton, NH (US)

Correspondence Address: BAE SYSTEMS, PO BOX 868, NASHUA, NH, 03061-0868, US

(73) Assignee: BAE SYSTEMS INFORMATION AND ELECTRONIC SYSTEMS INTEGRATION INC., Nashua, NH (US)

(21) Appl. No.: 11/632,669

(22) PCT Filed: Mar. 30, 2006
(86) PCT No.: PCT/US06/11699

§ 371 Date: Jan. 17, 2007

Related U.S. Application Data
(60) Provisional application No. 60/668,321, filed on Apr. 4, 2005.

(51) Int. Cl. G06F 15/18

(52) U.S. Cl. 726/23

(57) ABSTRACT

Honey pots are used to attract computer attacks to a virtual operating system that is a virtual instantiation of a typical deployed operational system. Honey nets are a collection of these virtual systems assembled to create a virtual network. The subject system uses a forward deployed honey net combined with a parallel monitoring system collecting data into and from the honey net, leveraging the controlled environment to identify malicious behavior and new attacks. This honey net/monitoring pair is placed ahead of the real deployed operational network and the data it uncovers is used to reconfigure network protective devices in real time to prevent zero-day based attacks from entering the real network. The forward network protection system analyzes the data gathered by the honey pots and generates signatures and new rules for protection that are coupled to both advanced perimeter network security devices and to the real network itself so that these devices can be reconfigured with threat data and new rules to prevent infected packets from entering the real network and from propagating to other machines. Note the subject system applies to both zero-day exploit-based worms and also manual attacks conducted by an individual who is leveraging novel attack methods.

### RELATED APPLICATIONS

This Application claims rights under 35 USC § 119(e) from U.S. Application Ser. No. 60/668,321 filed Apr. 4, 2005, the contents of which are incorporated herein by reference.

### FIELD OF THE INVENTION

This invention relates to a method and apparatus for preventing zero-day exploit-based network attacks and more particularly to the utilization of a honey net to provide a virtual instantiation of a real network in parallel with a monitoring apparatus used to detect and prevent a zero-day exploit worm or manual attack from being effective against the network.

### BACKGROUND OF THE INVENTION

One of the most serious and potentially catastrophic types of computer attacks are the so-called zero-day worm-based attacks or exploits against an enterprise network. The result of a zero-day worm attack would be catastrophic. An effective defense system for the zero-day worm-based attack would desirably result in some small number of computers that would actually be affected, with the remainder of the computers on the enterprise network being protected within a few minutes.

The term zero-day refers to exploits or attacks that are based on vulnerabilities in computer systems that are known but for which patches are not available. In short, in a zero-day exploit, there is nothing within the computer network defense community that is able to fix the vulnerability that the worm is taking advantage of.

Typically, when designers of operating systems become aware of vulnerabilities in their systems, so-called patches are transmitted out to the computing community so that perimeter firewalls are kept up to date to isolate and turn back the worm attacks. While the manufacturers of the operating systems constantly check for vulnerabilities and provide corrective software patches, oftentimes system administrators do not or cannot keep up with all of the patches.

Advanced worm protection systems include intrusion detection systems, which are either anomaly-based or signature-based approaches for looking for “bad things” in data streams. Anomaly-based systems operate on statistical guesses as to what can go wrong with a generalized enterprise network and try to intercept and protect based on these guesses. The problem is that there is not necessarily a good correlation between general anomalies and anomalies seen in a live network due to the non-deterministic nature of user behavior, live network activity, etc.

The result is that anomaly-based systems typically have unacceptably high false alarm rates because they are looking through large volumes of data to ascertain what is valid or invalid traffic. Moreover since there are false positives an expert in the field is required to parse through all of the alerts to ascertain which are significant and which are not.

Static-based approaches are the signature-based approaches that use snapshots of worms or viruses and utilize pattern-matching techniques to detect data that has something bad about it. This approach is similar to anti-virus packages that sit on the desktop, which have a library of “bad things” that are simply compared to ascertain if a virus is present.

The single most important problem with intrusion detection systems is the high false alarm rate for anomaly-based approaches. Moreover, signature-based approaches are obviously only as good as their signature library. If either of these approaches has not seen what is spreading, they literally have no way to defend against it. Thus, if a worm has not been seen, then matching techniques can be to no avail.

As explained above, zero-day (also known as O-day) means that a vulnerability is known about but has not been patched and can cause significant damage because defensive systems are not anticipating the particular zero-day exploit.

Thus, for instance, if there is a vulnerability in Windows that some hacker has discovered, Microsoft may or may not be aware of the situation. Moreover, the average person on the street, even an expert, may not be aware of the exploit. Note that the vast, majority of all worms are based on known vulnerabilities. In most cases exploits taking advantage of published vulnerabilities are usually available on the Internet within days of the published information surrounding the vulnerability, although in some cases this window has been measured in hours.

Even for known vulnerabilities, each individual enterprise system is in a varied state of patch readiness. The enterprise system has either been patched and is protected, or it has not been patched because the system administrator has not been able to deploy the patch.

For zero day-based worms, at the time they are deployed they attack an unknown vulnerability. Thus the problem with a zero day-based worm is that no one will be patched against the worm on the system level. In the case of a zero-day worm, the vulnerability will be pervasive against the Internet. Everyone's fear is that there will be a catastrophic day where someone creates a robust, capable, fast-spreading worm that takes advantage of zero-day pervasive exploits and attacks some core operating system, after which the worm spreads over the entire network in a short period of time, assuming it bypasses firewalls.

It is noted that a worm is a self-propagating, network-based infection that spreads from computer to computer autonomously. A virus is a piece of code that infects a file that gets moved around and spreads by itself. The distinction is that a virus requires the opening up of a file and therefore it requires human intervention. On the other hand, a worm is a process that sits on a machine and automatically sends packets out by itself to other machines. These packets then automatically bore holes into other machines, cuddle into the machine, and infect the machine; and then continue by itself with no human intervention required. Thus, while a virus requires downloading of and/or interaction with a file, a worm does not require downloading or any human involvement.

One concept to address zero-based worms is to sense an increase in the data transmission rate within the system and to throttle the data to a crawl in order to try and slow down the propagation of the worm until such time that somebody can protect the system. These types of systems (sometimes called Tarpits) in essence act like choke points that will limit data flow if a machine tries to send out an exorbitant amount of data very quickly. If a machine is suddenly trying to reach every machine on the network, this is taken as a sign that it has been infected. Thus prior systems put a throttle in place to limit the number of packets that can get through the system per second. However, all this does is delay the infection so that people will have time to respond. The problem with the threshold is where one is going to set the threshold, the exceeding of which chokes off everything such that the throughput is at a snail's pace to create a fair amount of time to react. However, if one throttles down the network too much, the system is useless as the network will be rendered unusable.

There are those in the industry who have talked about improving host-based intrusion detection systems where typical desktop machines or hosts have anti-virus packages that include a signature-based protocol that looks for “bad things” utilizing snapshot matching techniques.

Host-based intrusion prevention systems are more dynamic. They are usually based on anomaly detection, which analyzes the operation of the machine to see if it is performing the way it should be. If it is not performing the way it should be because anomalies exist, then these systems seek to kill the process and flag an alert. What these systems do is to try to dynamically recognize something in the behavioral pattern of the machine and to recognize when the machine is exhibiting behavior that does not appear to be valid.

The problem with host-based, anomaly-based systems is that the machine is monitoring itself and as soon as the system is infected with a virus; one has another process that is trying to protect against the virus that has already infected the machine. The problem is that by the time one has detected the anomaly, this process has infected the machine and therefore it is virtually impossible to guarantee that the infected process won't subvert the detection methodology.

By way of example, assuming an anti-virus software such as McAfee or Symantec, it may be on line searching for bad processes. First of all, there is some sort of probability-based or pattern-based matching approach that is going to be used. If this process spawns or creates a new user account, that is automatically suspect. If the process is putting root kit software on the machine, this is something that the anti-worm software can look for.

A proven theorem in computer science is no program can predict with 100% accuracy what another software package will do. This is described by Fred Cohen in “Computer Viruses-Theory and Experiment,” Computer and Security, Vol. 6, No. 6, 1987, p. 22-35. The reason that no program can predict with 100% accuracy is because if Software A is trying to predict what Software B will do, all Software B has to do is generate code that says, “look for whatever Software A predicts that Software B will do and then do something different”. Thus, in this logic loop, another software package cannot always predict what the first software package is going to do. As a result, if this virus or worm gets into a machine, it could subvert both the detection methodology that the intrusion prevention software on the machine is trying to look for. Even if the anomalies are detected, the worm could nonetheless compromise the software by killing the host process or altering its files.

Moreover, some systems utilize root kit detection, which is a hardware-based package that looks for software that is trying to hide its existence in a machine. The hardware is a standalone hardware card that is placed in the PC and monitors the integrity of the file system and memory to make sure that someone is not trying to subvert the kernel by hiding itself. However, this system has a number of drawbacks, the first of which is that it is very expensive. One has to buy a dedicated hardware card for each machine. Second, the card would have to go on every machine one wants to protect. Third, it is only looking for root kits, that is, software that is subverting the kernel to hide itself. It is not looking for things that are infecting the machine. Thus, if one seeks to infect a machine and does not try to hide the existence of the worm, this defensive mechanism is useless because it only looks for software that is trying to hide its existence on the machine.

Moreover, there are network-based anomaly-pattern systems so that instead of just looking at a file system, they try and look across the network and collect signatures or statistics that would be useful in detecting a broad-scale attack. However, this is even further fraught with the problems with anomaly-based systems and ultra-high false alarm rates.

In the past, there have been so-called honey pot systems that are used to attract threats and attacks, one of which is a wireless network security system described by Tyson Macaulay in US Patent Publication No. US 2003/0135762. This system is focused exclusively on wireless networks and specifically on 802.11 networks. In this system, the honey pot is used exclusively at the data link and the network layers, simulating a wireless access point. It is the entire purpose of the Macaulay system to detect unauthorized users of the system and to disconnect them. The system is not looking for worms or exploits or even attacks, but rather simply recognizes when one is not authorized to access the wireless network. The Macaulay system in essence puts out a fake access point and attempts to get people to connect to that access point. If the person tries to connect to the fake access point, they must not be valid users and therefore they will be disconnected and marked for future reference. Thus, the Macaulay system is only looking for invalid computers that are trying to access a wireless network by sending out probes to join the network.

In short, authorization or authentication systems are not interested in detecting, classifying and thwarting worms. Moreover, the results from current honey pot systems are analyzed by humans, where they sit down and go through log data and try to understand what happened. It is primarily the human element that is used to ascertain what kind of new technique or root kit is being used and then to deploy patches to counter the detected threat. However, any system that involves human intervention would be much too slow to prevent a zero-day worm attack.

Access control is also described in the Griffith et al. patent application US Patent Publication No. US 2004/0049699, which looks to see if packet data is valid. This system focuses on people making a connection to the network that should not be allowed, and is an access point-based system. Note that this type of system also has nothing to do with computer exploits or worms or compromising systems, but rather relates to gaining access to a wireless network. Michael T. Lynn and Scott Hrastar also describe an 802.11 system in US Patent Publication No. US 2003/0233567 that looks for inappropriate 802.11 traffic at the data and network layers and then reacts accordingly to limit access by an authentication mechanism, rather than an exploit protection system.

Moreover, in US Patent Publication No. US 2002/0157021 by Sorkin et al., what is described is another type of honey pot system. This publication basically describes how to create a honey pot and is an artificial system used to trick an attacker into spending time in the honey pot, so while the attacker is spending time in the honey pot one can monitor what the attacker is doing. However, the system described in this publication makes no claims for detecting or preventing zero day-based or any other types of attacks. Rather it is simply an information-gathering tool.

As will be appreciated, there are a number of public domain honey pot algorithms that function as information-gathering tools. The honey pot is essentially an environment or sandbox in which an attacker would go and spend time, with the system collecting data as to what the attacker is doing in the sandbox. With these honey pot systems, a human being must go in and look at the data to ascertain what the attacker is doing, but the honey pot software in and of itself does not make any decisions or take any action.

US Patent Publication No. US 2002/0133717 by Ciongoli et al. is yet another type of honey pot system that presents false data to an attacker to stall him for monitoring and inspection purposes. This type of honey pot system is often called a “tar pit” in which the attacker is diverted into this fake system or virtual collection system. The attacker would spend time scanning and exploiting and exploring these virtual systems that are not real, and their exercise of the system would alert the enterprise to give the enterprise time to ready its defenses if the enterprise has some intrusion detection system that has been put on alert that something suspicious is going on. However, this type of system requires a person in the loop to go and investigate some possible bad activity. These types of man-in-the-loop systems require an expert in the field to be monitoring all the possible alerts and then spend time manually investigating the system to find what the attacker is doing. These systems are at most effective against real-world, physical human attackers and are not effective against network-based worms that are autonomously going out to compromise systems in a matter of seconds.

With respect to another Sorkin approach described in US Patent Publication No. US 2002/0162017, this approach does not claim to detect anything or prevent anything. It is a method to redirect traffic to a honey pot once an attacker has been identified by an outside source. It assumes that somehow one can identify that someone is attacking the network, and after having detected the attacker's presence, divert them to a honey pot to spend time in the honey pot. However, since it uses a honey pot only when one has detected something is amiss, it does not work for protecting enterprise networks against new attacks such as zero-day based worms.

There is a patent publication entitled “Collaborative Suppression of Undesirable Computer Activity,” by DeClouet, namely US Patent Publication No. US 2004/0015718, that makes no claims to have identified new techniques for either detecting exploits, stopping exports or protecting them, but rather to have a proposed framework comprised of sensors that detect an attack, and then have a feedback system to simply feed the data to an entity that can protect the network. This patent publication does not propose any new sensor techniques or systems that would actually solve the problem, but rather simply describes how one would plug devices together in a network.

As to the Triulzi et al. US Patent Publication No. US 2004/0117478, this is a technique that is relatively detailed and is a method for analyzing network traffic with the objective of detecting attacks. It does not imply any response to the attacks but rather that it will collect data passively on a network, like a network sniffer. In fact, the algorithms in the Triulzi et al. application are called “packet sniffers,” which monitor data and then have a tree diagram of how one might analyze the data looking for an attack. In short, the Triulzi et al. patent publication describes a data collection system that does not discuss honey pots.

In essence, the Triulzi et al. system revolves around how to create an intrusion detection system and how one would place oneself at an entry point in a network, monitor packets that are coming through and identify or attempt to identify and draw some conclusions or at least provide data that an analyst can draw conclusions from regarding the activity.

The disadvantage to intrusion detection systems and intrusion prevention systems is that they do not have a known baseline of valid activity on which to draw conclusions. They can only draw from a statistical pattern of what typical network traffic looks like. On a live enterprise network there may be as many as 50 million packets of HTTP traffic. These systems have to assume that if there is an increase of traffic above some kind of threshold that is typical or valid, then there is an attack in progress. Note that this system does not refer to honey pots at all and does not take advantage of detecting or stopping zero-day attacks.

### SUMMARY OF INVENTION

The subject system provides zero-day worm defenses by placing a honey pot system at a forward-deployed position in an enterprise network so that it is attracting zero-day worms before any node on the network is attacked. The honey pot system is specifically configured as a virtual network that is an instantiation of the real network. It is thus created to look and act like the real network. Traffic coming into the system or out of the system exercises processes within the honey pot virtual network, called a honey net, so that non-normal operation is quickly spotted. This non-normal operation does not depend on some statistical anomaly prediction based on a live generalized network, but rather is specific to the actual real network and its processes and more importantly, measured in a controlled, predictive environment.

The subject system is not an anomaly-based detection system, which has a problem of false positives, but rather is a completely duplicate system of the enterprise network so that one does not have to utilize the general statistics or anomaly programs but rather can see in real time data that infects the particular enterprise system involved. Because there are no real or live users or actual legitimate packages running, any unusual behavior can be tied directly the actions of the attacker and used to characterize the methods used in the attack.

Because the software in the virtual honey pot network is essentially identical to the software in the real network it can be assumed this attack would be successful against the real network and must be prevented.

In one embodiment, in order not to have to process all of the data that is coming into the enterprise system, the honey net is loaded with unused IP addresses such that if any of the unused IP addresses are accessed from the outside, it is determined immediately that a zero-day worm may be present. The number of unused addresses is an order of magnitude more than the number of addresses used in the enterprise network. This ensures the likelihood that a random IP-address based attack will access an unused IP address before a legitimate address is quite large.

Upon detecting an attacker, the parameters of the attack are ascertained and raw honey net activity data is coupled to a monitoring system that outputs threat data and new rules, settings, tables, signatures or patterns. This threat data is used either by advanced perimeter security devices to set their firewalls or by process in the real network so as to block data coming down the network pipe having these characteristics.

In one embodiment, data from the Internet is first coupled to a simple perimeter detection device to, for instance, eliminate the usual spam and other simple attacks on the system. The simple perimeter device limits the amount of data sent to the honey net so that the honey net-based exploit detection and prevention system need not be needlessly clogged with unwanted data.

The likelihood in this embodiment of an attacker accessing an IP address that is used by the real network is very small since one or more orders of magnitude of the addresses available are assigned to the honey net-based exploit detection and prevention system that operates as a forward network protection system. To prevent targeted attacks utilizing known IP addresses or the few random scans that might access the real network, traffic diversion techniques could be employed such as those described in “Detecting Targeted Attacks Using Shadow Honeypots” by Anagnostakis et al., although this approach relies on the ability of an anomaly detector to correctly detect and classify suspicious traffic and the honey net to be able to handle diverted traffic.

The threat data and new rules, including signatures, anomalies and other flagged items, in one embodiment are coupled to advanced perimeter security devices, which have their own firewall, with the threat data and new rules being used to quickly configure the firewall to block the offending data in the network pipe from reaching the real network. The advanced perimeter security device therefore constitutes a network-level protection system.

On the other hand, the same threat data and new rules are applied to the real network, which includes protection processes within a host server, router or other internal application levels. These processes are provided with firewalls and protective means that can be quickly reconfigured to block data coming into the real network having the detected characteristics of an attack.

Rather than using generalized algorithms for anomaly detection that may or may not correspond to how the real enterprise network is working, and rather than utilizing throttling techniques or techniques, in the subject system the forward network protection system comprises a controlled, virtual network that can be linearly correlated to the real network so that one does not have to guess using standardized algorithms, whether or not what is detected by the forward network protection system will infect the real network.

Examples of data that can be monitored for malicious behavior include stack changes, register states, malformed packets, port numbers, IP addresses, user account changes such as permissions and new creations, disk activity, memory usage, etc. can all be monitored to detect and describe the type and character of the attack. Since the incoming raw data packets are captured along with time stamps the packets correlating to the compromise of the virtual system can be readily identified. The difference between the honey net behavior and its programmed behavior provide a measurement baseline describing the attacker's method and can be combined with normal host and/or network anomaly detection techniques to characterize the attack.

In the above embodiment, the output of the simple perimeter detection devices is partially filtered data that goes to the forward network protection system and also to the advanced perimeter security devices, thus to limit the workload that could under ordinary circumstances constitute millions of packets as described in the attached figures.

Note the threat data includes information about the services that are being compromised, the types of packets that are being used to compromise the system (port, protocol, number of packets, size of packets, payload type, etc.), the IP address of the attacker, and other data. The anticipated response is to change the defensive posture of the network to reflect this new information. Examples of expected changes include firewall settings, intrusion detection settings, router configurations and perhaps even the patches utilized by the enterprise system to protect the enterprise system against this attack.

In short, the subject forward network protection system is configured to closely resemble the enterprise system and constitutes a virtual network configured as a honey pot to attract incoming attacks and to ascertain the existence of an incoming attack, not by generalized algorithms that relate to all types of enterprises systems but rather by detecting the processes running on a virtual network machine that mimics the real network.

Thus, honey pot and honey net technology is used in combination with advanced monitoring, detection and analyzing logging software deployed in parallel to monitor the virtual target environment and are placed ahead of a real deployed operational network. The subject system acts in real time analyzing the data gathered by the honey pot to generate threat data, including signatures and new rules, that is fed to both advanced perimeter network security devices and to the real network itself so that these devices can be reconfigured with the threat data to prevent the worm from propagating.

In summary, a honey pot system is placed at a forward-deployed position in the network so that it is attracting zero-day worms before any system on the network is attacked. This forward network protection system includes a virtual network created to look like the real network it protects so that any traffic coming into the system is analyzed in advance for invalid data packets or anomalies. In one embodiment, the forward network protection system is loaded with unused IP addresses, normally at least ten times the number of IP addresses that are used on the real network, so that attackers using IP address scanning will be detected before any real addresses in the network are accessed by the attacker. Many other techniques to ensure the attacker targets the virtual network may be employed as well, perhaps using the one described in US Patent Publication US 2002/0162017 or others not described here. All data going into the honey pot is either accidental or hostile and can be analyzed as such. Stack behavior, register states, malformed packets, user accounts, disk activity, memory usage, etc. can all be monitored to detect and describe the type and character of the attack. Once identified and threat data has been created this data is provided to advanced perimeter security devices and the real network so that packets having these characteristics are prevented from entering into the real network. Because the parallel monitoring system is physically and logically separate from the honey net, even if the honey net virtual environment was compromised the monitoring system would not be and would still be able to characterize the attacker and provide this data to the subscribing defensive devices.

### BRIEF DESCRIPTION OF THE DRAWINGS

These and other features of the subject invention will be better understood in connection with the Detailed Description, in conjunction with the Drawings, of which:

FIG. 1 is a block diagram of the subject system, showing the forward position of the forward network protection system that includes a virtual network that duplicates the enterprise network to provide early detection of processes that are running non-normally and to reconfigure intrusion protection devices to block packets having the characteristics detected as well as data transmitted from the IP address identified as having generated the attack; and,

FIG. 2 is a detailed block diagram of the forward network protection system of FIG. 1, illustrating a monitoring module that takes raw data from a virtual honey pot network and outputs threat data and new rules to devices at the network level and to the host server, routers and individual application levels within the real network.

### DETAILED DESCRIPTION

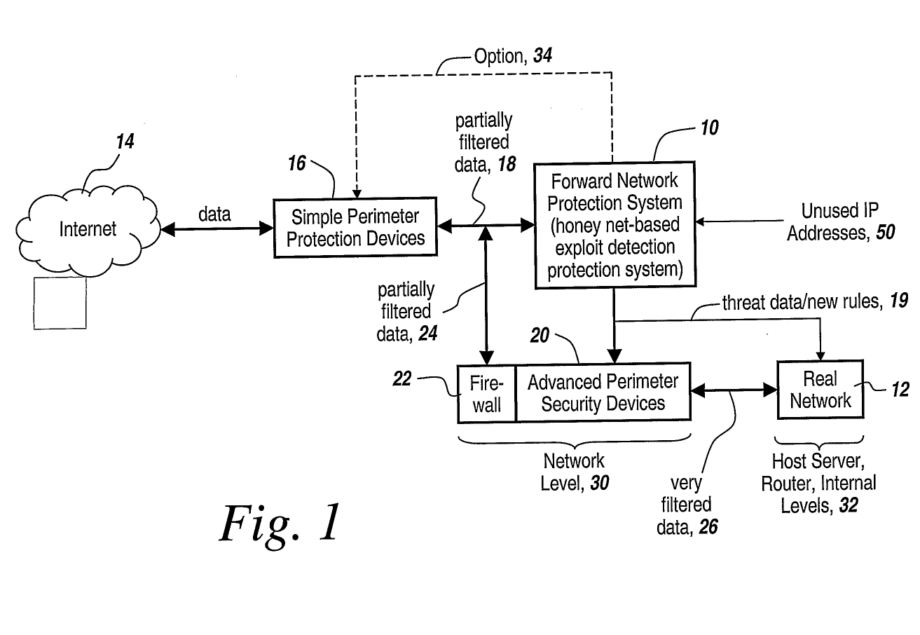

Referring now to FIG. 1, a honey net-based exploit detection and prevention system 10 is presented, herein referred to as the forward network protection system. This protection system is deployed forward of the real network 12 and is connected to the Internet 14, in one embodiment through a simple perimeter protection device or devices 16. These devices provide a partially filtered data stream 18, with the simple perimeter protection devices, for instance, eliminating spam and unwanted email.

It is the purpose of the forward network protection system to detect a worm attack, which exercises processes within the virtual network contained within the forward network protection system.

Unlike anomaly detection systems, which look for generalized anomalies within processes, in the subject system the forward network protection system is configured identically to the real network and functions as a virtual copy of the real network so that any processes that provide unusual or unexpected results are immediately flagged as having been attacked. Thus there is no necessity for generalized anomaly detection, since the subject system detects unexpected results on the exact same network that is being attacked.

In one embodiment the honey net-based exploit detection and prevention system quickly detects an attack by providing the forward network protection system with a large number of unused IP addresses. Network 12 has associated with it a number of users and a number of used IP addresses. The number of unused IP addresses for the forward network protection system is typically ten-fold that of the used IP addresses, which means that when an attacker scans system utilizing synthetically generated IP addresses, 99 times out of 100 they will not refer to a real IP address in network 12. Rather, the address shows up as a unused IP address, at which point the forward network protection system analyzes the incoming data packets to ascertain what type of attack is ensuing and to provide threat data and/or new rules to automatically update an advanced perimeter security device 20, which has a firewall 22 that is configured to reject the partially filtered data 18, which comes in over the network pipe 24.

This protection occurs automatically by virtue of the operation of the forward network protection system, with the advanced perimeter security devices being updated to block worm-infested packets from reaching the real network over data pipe 26.

Thus the data over data pipe 26 corresponds to very filtered data, which is filtered as can be seen at the network level 30.

Real network 12 is also provided with its own protection applications and the threat data and rules delivered over line 19 to the advanced perimeter security devices 20 are also delivered over line 19 to the real network, which in essence includes the host, the servers, the routers and internal level applications, as illustrated at 32. Thus in the case that the advanced perimeter security devices do not result in blocking infected packets, there is yet a further level of protection by reconfiguring the protection devices within real network 12.

In an optional embodiment, as indicated by dotted line 34, data from the forward network protection system can also be used to reconfigure the simple perimeter protection device 16. However, if an attacker knows that a forward network protection system is in operation, they may be able to bypass the forward network protection system by probing it to see its unused addresses and thereby transmitting used addresses. Thus it may not be in the best interest of network security to configure the simple perimeter protection devices upon the detection of a zero-day worm.

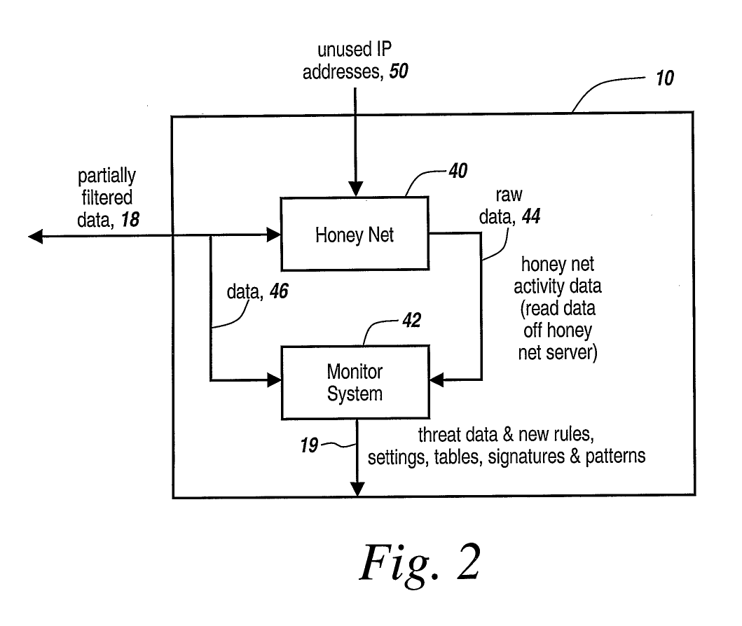

Referring now to FIG. 2, forward network protection system 10 includes a honey net 40, which is a network that is the virtual instantiation of real network 12 of FIG. 1. Partially filtered data 18 arrives at the honey net, where it is inputted to the virtual network and also is inputted to a monitoring system 42. Raw data from the honey net, here illustrated at 44, is an input to the monitoring system. The monitoring system is used to detect unexpected outputs from the honey net and based on the data inputted over line 46, generates threat data over line 19 as discussed in FIG. 1. The threat data can include data, new rules, settings, tables, signatures and patterns, which can be utilized by either the advanced perimeter security devices 20 of FIG. 1 or the security devices deployed within the real network 12 of FIG. 1. Thus the information or data on line 19 is the aggregated raw threat data and new rules and new router settings, which are configured to counter the threat by blocking potentially infected data packets.

As before, the unused IP addresses, here illustrated at 50, are inputted to the honey net so that incoming data attempting to address these unused IP addresses immediately alerts the forward network protection system of a worm attack. This immediately results in raw data read off of the honey net server that is the result of access using the unused IP addresses. This honey net activity data is then analyzed by monitor 42 in combination with input of the data stream to honey net 40 to be able to timewise analyze, packet by packet, the characteristics of the attack and to put out timely threat data and new rules, settings, tables, signatures and patterns to follow on protection processes.

What will be appreciated is that one has deployed a forward network protection system that is a virtual copy of the real network or a substantial portion thereof so that its processes will mimic those of the real network, such that when these processes are attacked by zero-day worms, the system can rapidly analyze what is happening and configure the advanced perimeter security devices to block the appropriate packets.

While the present invention has been described in connection with the preferred embodiments of the various figures, it is to be understood that other similar embodiments may be used or modifications or additions may be made to the described embodiment for performing the same function of the present invention without deviating therefrom. Therefore, the present invention should not be limited to any single embodiment, but rather construed in breadth and scope in accordance with the recitation of the appended claims.

What is claimed is:

1. A method for protecting a real deployed network against zero-day worm-based attacks using infected data packets, comprising the steps of:
forward-deploying a virtual network that operates similarly to the real network it is to protect, the virtual network coupled to a communications network;
providing the virtual network with a honey pot algorithm designed to attract zero day-based worm attacks in which the honey pot application detects the presence of infected packets from a zero-day worm and provides raw data as to the operation of the virtual network;
upon detection of activity within the virtual network that is unexpected, analyzing the raw data to generate threat data; and,
deploying an advanced perimeter security device coupled between the real network and the communications network to utilize the threat data to configure itself to block infected packets, whereby the real network is protected from zero day-based worm attacks.

2. The method of claim 1, and further including the step of providing the real network with at least one protection application and coupling the threat data to, the protection application to reconfigure the protection application to block infected data packets that get through the advanced perimeter security device, thereby to offer a further layer of protection to the real network.

3. The method of claim 1, and further including the step of pre-processing the data from the communications network utilizing a simple perimeter detection device that outputs partially filtered data and couples the partially filtered data to the virtual network.

4. The method of claim 3, and further including the step of providing threat data from the virtual network to the simple perimeter protection device to configure the perimeter protection device to block infected data packets.

5. The method of claim 1, wherein the threat data is taken from the class consisting of new rules, settings, tables, signatures and patterns that characterize infected data packets.

6. The method of claim 1, wherein the advanced perimeter security device includes a firewall and further including the step of setting the firewall parameters to block infected data packets based on the threat data.

7. The method of claim 1, wherein the honey pot application attracts zero-day worm infected data packets by supplying the honey pot application with IP addresses that are not used by the real network, the detection of data packets addressing an unused IP address indicating a worm attack.

8. The method of claim 7, wherein the number of unused IP addresses is at least an order of magnitude greater in number than the number of IP addresses used in the real network, whereby the probability in an automatic zero-day worm attack involving scanning IP addresses is that it is more likely that the scanning will generate an unused IP address than to generate a used IP address, thereby to permit the forward-based virtual network to detect a zero-based worm attack prior to the processing of infected data packets by the real network.

9. A system for protecting a deployed operational network from a worm attack involving infected data packets, comprising:
a forward network protection system coupled to the Internet, said forward network protection system including a honey net-based exploit detection protection system, said honey net-based system at least partially instantiating said real network;
a network worm detection module within said forward network protection system for detecting a worm attack and for generating threat data based on the detected worm attack; and,
an advanced perimeter security device coupled to said Internet and to said threat data for blocking infected data packets from reaching said real network based on the generation of said threat data, whereby said forward network protection system detects a worm attack prior to infected data packets being coupled to said real network.

10. The system of claim 9, wherein said advanced perimeter security device includes a firewall and wherein said threat data is used to set said firewall to block infected data packets from the Internet from reaching said real network.

11. The system of claim 10, wherein said real network includes a protection application and wherein said threat data is coupled to said protection application to reconfigure said protection application to block the corresponding infected data packets.

12. The system of claim 11, and further including a perimeter protection device interposed between the Internet and said forward network protection system for at least partially filtering data from the Internet prior to coupling said filtered data to said forward network protection system, thereby to reduce the workload on said forward network protection system.

13. The system of claim 12, and further including a circuit for coupling said threat data to said perimeter protection device to configure said perimeter protection device to block infected data packets.

14. The system of claim 9, and further including a number of unused IP addresses coupled to said honey net-based system and a monitor coupled to the output of said honey net-based system for analyzing the raw data therefrom when an unused address is accessed by incoming data packets, and for generating said threat data responsive thereto.

15. The system of claim 14, wherein said real network has a number of used addresses and wherein said number of unused addresses is at least on an order of magnitude larger in number than the number of said used addresses.

16. A false alarm-free system for protecting a deployed operational real network against a zero day-based worm attack, comprising:
a forward network protection system including a virtual network that is at least a partial instantiation of said real network;
a module within said forward network protection system that upon detection of infected data indicating the presence of a zero day-based worm, outputs threat data, said module operational to detect unexpected activity in said virtual network for detecting the presence of the zero-day worm attack; and,
a perimeter security device coupled to said threat data and to the Internet to block infected data packets associated with the detected zero-day worm from reaching said real network, whereby said forward network protection system relies on detection of unexpected activity in said virtual network that, because it is an instantiation of the real network, provides false alarm-free zero-day worm protection.

17. The system of claim 16, wherein said forward network protection system provides a controlled environment for the analysis of data packets from the Internet.

18. The system of claim 17, wherein said controlled environment consists of the running of processes within said virtual network, the results of which are used only to generate said threat data.

19. The system of claim 16, wherein said threat data is taken from the group consisting of new rules, settings, tables, signatures and patterns that characterize infected data packets.

20. A method for protecting a network from a zero-day worm attack, comprising the steps of:
deploying a forward network protection system including a virtual network that is at least a partial instantiation of the real network;
detecting processes running on the virtual network;
analyzing the results of the processes run on the virtual network to detect unexpected activity;
generating threat data to be used in blocking the infected packets that caused the unexpected activity; and,
responsive to the threat data, blocking the infected packets to prevent the infected packets from entering the real network.

21. A method for protecting computer networks against attacks including zero-day exploits and self-propagating worms, comprising the steps of:
forward-deploying a virtual network that operates similarly to a real network it is to protect, the virtual network coupled to a communications network;
configuring the virtual network as a honey net representative of the real network and designing the honey net representation to attract attacks;
providing an adjacent monitoring system to detect the fact that a successful attack has occurred in the representative honey net;
upon detection of activity within the virtual network that is unexpected, analyzing the raw data to generate threat data and defensive network device settings;
providing the threat data and defensive network device settings to subscribing devices in the real network; and,
deploying an advanced perimeter security device coupled ahead of the real network to be protected to utilize the threat data or device settings provided by the honey net and monitoring system to configure itself to block infected packets, thereby protecting the real network.

22. The method of claim 21, wherein the subscribing devices include at least one protection application, and further including the step of coupling the threat data to the protection application to reconfigure the protection application to block infected data packets that get through the advanced perimeter security device, thereby to offer a further layer of protection to the real network.

23. The method of claim 21, and further including the step of pre-processing the data from the communications network utilizing a simple perimeter detection device that outputs partially filtered data and couples the partially filtered data to the virtual network.

24. The method of claim 23, wherein the perimeter security device is taken from the group consisting of intrusion detection/prevention systems, firewalls and routers.

25. The method of claim 21, wherein the threat data is taken from the class consisting of new rules, settings, tables, signatures and patterns that characterize infected data packets.

26. The method of claim 21, wherein the advanced perimeter security device includes devices taken from the group of firewalls, packet-inspection systems and intrusion detection/prevention systems, and further including the step of setting the device parameters to block infected data packets based on the threat data.

27. The method of claim 21, wherein the honey net attracts zero-day worm infected data packets by supplying the honey net with IP addresses that are not used by the real network, thereby to attract attackers to the virtual network.

28. The method of claim 27, wherein the number of unused IP addresses is at least an order of magnitude greater in number than the number of IP addresses used in the real network.

29. A system with radically reduced or eliminated false alarms alarm for protecting a deployed operational real network against a zero day-based worm attack arriving over the Internet, comprising:
a forward network protection system including a virtual network that is at least a partial instantiation of said real network;
a module within said forward network protection system that upon detection of infected data indicating the presence of a zero day-based worm, outputs threat data and device settings, said module operational to detect unexpected activity in said virtual network for detecting the presence of the zero-day worm attack; and,
a perimeter security device coupled to said threat data and to the Internet to block infected data packets associated with the detected zero-day worm from reaching said real network, whereby said forward network protection system relies on detection of unexpected activity in said virtual network that, because it is an instantiation of the real network, provides reduced or eliminated false alarm zero-day worm protection.

30. The system of claim 29, wherein said forward network protection system provides a controlled environment for the analysis of data packets from the Internet.

31. The system of claim 30, wherein said controlled environment consists of the monitoring of processes, ports, file system activity, input/output data, account information, memory and processor loading, code branching, signatures, statistics, and other relevant data useful for recognizing malicious activity within said virtual network, the results of which are used to generate said threat data and derive defensive device settings.

32. The system of claim 29, wherein said threat data is taken from the group consisting of attacker IP address, packet size, packet type, payload type, patterns, signature data, activity on compromised system, identified obfuscation techniques, targeted process/service/port, and wherein provided device settings are taken from the group consisting of new rules, settings, tables, signatures and patterns that are used to prevent access to the network from manual or automated attacks leveraging the identified attack vector.

33. A method for protecting a network from a zero-day worm attack, comprising the steps of:
deploying a forward network protection system including a virtual network that is at least a partial instantiation of the real network and an adjacent monitoring system;
monitoring activity of processes running on the virtual network;
analyzing incoming/outgoing traffic and the state of the virtual network to detect unauthorized activity; and,
responsive to the detection of unauthorized activity, blocking the associated infected packets.
